(19) United States
(12) Patent Application Publication
(10) Pub. No.: US 2026/0356251 A1
(43) Pub. Date: Nov. 12, 2026

(54) VEHICLE SEAT HAVING AN ADJUSTMENT DEVICE

(71) Applicant: Brose Fahrzeugteile SE & Co. Kommanditgesellschaft, Coburg, Coburg (DE)

(72) Inventors: Christian VETTER, Großheirath (DE); Marek STEHLIK, Rajec (SK); Thomas WEINGÄRTNER, Lichteneiche (DE)

(21) Appl. No.: 19/666,908

(22) Filed: May 4, 2026

(30) Foreign Application Priority Data
May 9, 2025 (DE) 102025117933.6

(51) Int. Cl. B60N 2/02; H02K 7/106; H02K 11/20; B60N 2/90

(52) U.S. Cl. CPC B60N 2/02253; H02K 7/106; H02K 11/20; B60N 2002/924

(57) ABSTRACT

A vehicle seat including a first component, a second component, an adjustment device with a motor and a transmission for adjusting the first component relative to the second component along an adjustment path, wherein the transmission is designed as a non-self-locking transmission, and a control system configured to put the motor into a braking mode for locking the first component relative to the second component.

### CROSS-REFERENCE TO RELATED APPLICATION

This application claims priority pursuant to 35 U.S.C. 119(a) to German Patent Application No. 102025117933.6, filed May. 09, 2025, which application is incorporated herein by reference in its entirety.

### SUMMARY

The proposed solution relates to a vehicle seat.

Vehicle seats are typically adjustable to adapt ergonomically to the body sizes of different passengers. Furthermore, some vehicle seats can be moved forward from an occupiable position of use into a position for easier entry and exit, e.g., in a pivoting and/or sliding manner, to allow passengers easier entry into and exit from a row of seats located behind the adjustable vehicle seat doing so by providing more space behind the vehicle seat. Such forwardly displaced position is typically referred to as an easy entry position.

To make such adjustments possible, many vehicle seats have motorized adjustment devices. Motorized adjustment devices in vehicle seats have hitherto been equipped with self-locking gears to prevent them from being adjusted manually or by other forces acting on the vehicle seat when the motor is inactive.

However, this reduces the efficiency of the entire motor-transmission to typically around 40%. The motor must be able to deliver a correspondingly high power and has a corresponding weight.

### DESCRIPTION

The object is to specify an improved vehicle seat.

This object is achieved by the subject matter having the features of a vehicle seat comprising:
a first component,
a second component,
an adjustment device having a motor and a transmission for adjusting the first component relative to the second component along an adjustment path, wherein the transmission is designed as a non-self-locking transmission, and,
a control system which is configured to put the motor into a braking mode to lock the first component relative to the second component.

Accordingly, a vehicle seat comprises a first component, a second component, an adjustment device with a motor and a transmission for adjusting the first component relative to the second component along an adjustment path, wherein the transmission is designed as a non-self-locking transmission, and a control system configured to put the motor into a braking mode for locking the first component relative to the second component.

In this way, a significantly higher efficiency can be achieved than with a self-locking transmission. Unintentional adjustment is prevented by putting the motor into braking mode, in which the motor prevents relative movement between the first component and the second component, e.g., via electromagnetic forces. The same adjustment speed can thus be achieved with a smaller motor with lower torque than with a more powerful and larger motor with a self-locking transmission. This makes a lower overall weight possible resulting in cost savings.

The motor can have at least two or exactly two electrical terminals. The motor is an electric motor. For example, the motor is a DC motor. It may be provided that the two or more than two terminals of the motor are short-circuited with one another in braking mode. Braking mode can mean that the motor terminals are short-circuited. As a result, a strong braking effect of the motor can be achieved against an adjustment caused by external forces.

The control system can comprise a full bridge. Full bridges are also referred to as H-bridges or H-circuits. For example, the motor is electrically connected via the full bridge to a supply voltage and to a ground potential. The full bridge makes it possible to operate the motor in opposite directions with the full supply voltage.

The full bridge comprises several, e.g., four, switching elements. The switching elements can in each case be semiconductor components (in particular power electronics). For example, the switching elements are each designed as IGBTs (insulated-gate bipolar transistors) or as MOSFETs (metal oxide semiconductor field-effect transistors), in particular power MOSFETs. Such switching elements make possible a fast, durable and lossless supply of electrical current to the motor for adjusting the first component relative to the second component.

For example, two of the switching elements are arranged between the motor and the supply voltage and are electrically connected thereto. Furthermore, two of the switching elements can be arranged between the motor and the ground potential and electrically connected thereto. The control system can be configured to open the switching elements between the motor and the supply voltage to disconnect the motor terminals from the supply voltage, and to close the switching elements between the motor and the ground potential in order to electrically connect the motor terminals to ground in order to put the motor into braking mode.

The first component could be a seat portion on which a passenger can sit. It may be provided for the first component (e.g., the seat portion) to be supported on the second component. The second component is, for example, a rail of a longitudinal adjustment device.

The adjustment device can comprise pivot elements, e.g., pivot arms, which are pivotably mounted relative to the first component and/or relative to the second component. This allows for a swinging adjustment of the seat portion (e.g., with a backrest mounted thereon), e.g., for height adjustment and/or to move the vehicle seat into an easy entry position.

The vehicle seat may further comprise at least one lock by means of which the first component can be locked in a predetermined position relative to the second component. For example, the lock locks the first component in the occupiable position of use. The lock can be opened to move the vehicle seat into the easy entry position. It may be provided for the lock to be capable of being opened electrically and/or for the lock to be capable of being opened manually.

For example, the control system comprises a lock switch, wherein a switching position of the lock switch indicates whether the at least one lock is locked or not. The lock switch can be designed in the form of a microswitch. The lock switch is, for example, arranged on the lock so that the lock switch is closed when the lock is locked, and open when the lock is open. In this way the control system can monitor the position of the lock.

The control system can be configured to put the motor into braking mode if the switching position of the lock switch indicates that the at least one lock is not locked. This means that such braking can be dispensed with if the lock is locked. If the lock is unlocked, the control system can activate the braking mode. In braking mode, the motor exerts a braking force.

The control system can have a sleep mode in which the control system is partially or completely deactivated. It may be provided for the control system to comprise a gate driver. The gate driver can be configured to put the motor into braking mode when the control system is in sleep mode and/or when the control system is put into sleep mode. In this way, it can be ensured that the motor can be put into braking mode even when the control system is inactive. Such a function can also be referred to as power-off braking.

The control system can comprise an interface and be configured to receive a command to enter sleep mode via the interface and to enter sleep mode in response thereto. Energy can thus be saved.

The vehicle seat can further comprise a position encoder which is configured to output a position signal indicating whether or not the first component is positioned in a predefined position along the adjustment path. The control system can be configured to control the motor of the adjustment device as a function of the position signal. For example, it may be provided for the motor to be put into braking mode only on one side of the position encoder's position, but not on the other, and/or it is provided for a predefined function (e.g., anti-pinch protection) to be activated only on one side of the position encoder's position.

The control system can be configured to determine a current position of the first component relative to the second component by counting a number of motor revolutions of the motor starting from an end position. The control system can further be configured to set the current position to a predetermined value when the position signal indicates that the first component is positioned in the predefined position along the adjustment path. In this way a position monitoring standardization is possible. This is relevant in particular when the control system is in sleep mode and the adjustment device is adjusted by an external force (e.g., manually). This is because the control system cannot count the motor revolutions while in sleep mode.

According to one aspect, a vehicle seat is provided, in particular according to any one of the embodiments described above. The vehicle seat comprises: a first component, a second component, an adjustment device with a motor for adjusting the first component relative to the second component along an adjustment path, a position encoder which is configured to output a position signal indicating whether the first component is positioned in a predefined position along the adjustment path or not, and a control system which is configured to control the motor of the adjustment device as a function of the position signal. Regarding the advantages, reference is made to what has been stated above. Additionally, in this way, anti-pinch protection can be limited to a relevant adjustment range, which makes a more robust adjustment possible.

The position encoder comprises, for example, a position switch, in particular in the form of a microswitch, which is configured to change a switching state when the first component reaches the predefined position during a movement along the adjustment path. This makes a particularly simple structure possible.

Alternatively or additionally, the position encoder can comprise a local mechanical deviation on the adjustment device (e.g., an elevation or depression on a guide device, e.g., a rail), which is detectable by the control system on the basis of a characteristic deviation in the operation of the motor when the first component reaches the predefined position during a movement along the adjustment path. This eliminates the need for additional components.

The characteristic deviation in the operation of the motor can be a local increase or decrease in rotational speed and/or current value.

The control system can be configured to detect an indicative value of a force acting on the adjustment device during activation of the adjustment device and to deactivate the adjustment device if the detected value exceeds a threshold. Such an excess force limitation can provide reliable anti-pinch protection.

The threshold can have a different value when the first component is positioned between the predefined position and one of two ends of the adjustment path than when the first component is positioned between the predefined position and the other of the two ends of the adjustment path. In this way, different levels of excess force limitation can be provided in different adjustment ranges and/or the excess force limitation to be activated only in certain adjustment ranges.

### BRIEF DESCRIPTION OF THE DRAWINGS

The idea underlying the present disclosure will be explained in more detail below with reference to the exemplary embodiments shown in the figures. In the figures:

FIG. 1 shows a schematic view of a vehicle seat having an adjustment device which supports a seat portion and a backrest of the vehicle seat;

FIG. 2 shows parts of the adjustment device of the vehicle seat according to FIG. 1;

FIG. 3 shows a motor and a transmission of the adjustment device of the vehicle seat according to FIG. 2; and,

FIG. 4 shows an electrical connection of the motor according to FIG. 3.

### DETAILED DESCRIPTION OF THE INVENTION

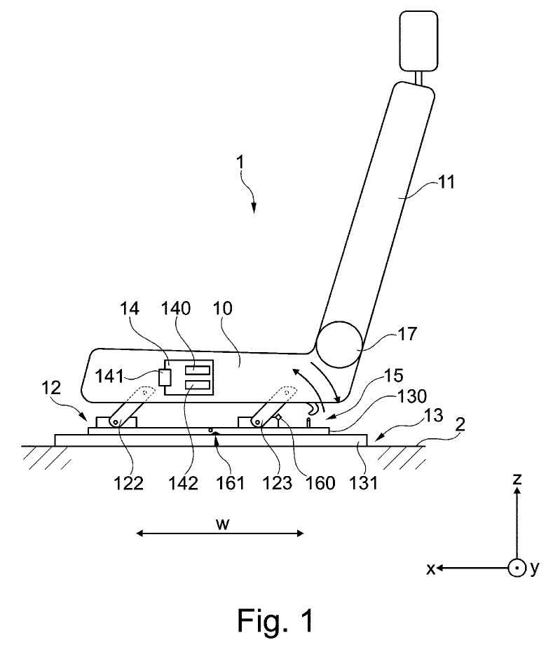

FIG. 1 shows a vehicle seat 1, which can be arranged, for example, as a front seat or as a rear seat in the second or third row of seats in a vehicle. The vehicle seat 1 has a first component in the form of a seat portion 10, on which a backrest 11 is arranged to be tiltable by means of fittings 17 and which is connected via an adjustment device in the form of an easy entry adjustment device 12 to a floor assembly in the form of a longitudinal adjustment device 13 for longitudinal adjustment of the vehicle seat 1 along a longitudinal direction X.

The longitudinal adjustment device 13 has two pairs of guide rails 130, 131, each arranged on one side of the seat portion 10 and spaced apart from one another along a transverse direction Y that is perpendicular to the longitudinal direction X. Lower guide rails, referred to herein as floor rails 131, are fixedly connected to a vehicle floor 2 and can be fixedly connected thereto in a pre-assembly state. In contrast, upper guide rails, referred to herein as seat rails 130, are coupled to pivot elements 120, 121 of the easy entry adjustment device 12. The longitudinal adjustment device 13 is connected to the seat portion 10 via the easy entry adjustment device 12.

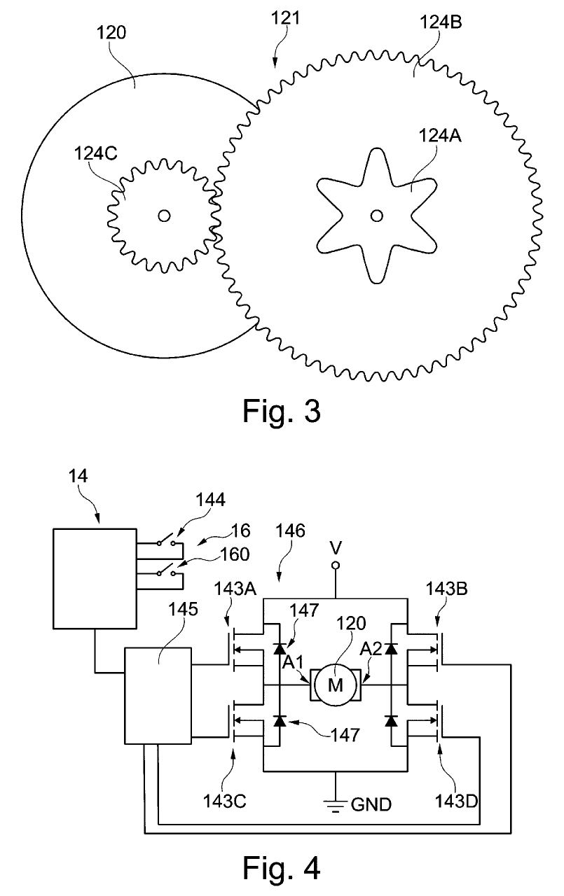

The pivot elements 120, 121 together with the seat rails 130 and the seat portion 10 form two pairs of four-bar linkages. For this purpose, the pivot elements 120, 121 are each pivotably connected at one end to the respectively assigned seat rail 130 and at the other end pivotably to the seat portion 10 such that by pivoting the pivot elements 120, 121 the height position of the seat portion 10 can be changed along a height direction Z (that is perpendicular to the longitudinal direction X and transverse direction Y). In this process, the seat portion 10 and the backrest 11 move along a curved path (see the arrows shown in FIG. 1). In this process, the seat portion 10 and the backrest 11 are moved from a position of use, in which a passenger can sit on the vehicle seat 1, into a forwardly displaced easy entry position. To effect the adjustment, the adjustment device 12 comprises (at least) a motor 120 and a transmission 121 (not shown in FIG. 1, but illustrated, for example, in FIG. 3). The motor 120 is an electric motor, in this case a DC motor (alternatively, for example, a brushless DC motor, BLDC).

The floor assembly, i.e., in this case the longitudinal adjustment device 13, supports the seat portion 10. The seat portion 10 supports the backrest 11.

The easy entry adjustment device 12 is an adjustment device for adjusting the seat portion 10 as the first component (and, because the backrest 11 is mounted on the seat portion 10 in the example shown, also the backrest 11) relative to the seat rails 130 as the second component in each case.

The adjustment device 12 with the motor 120 and the transmission 121 is configured to adjust the first component (seat portion 10) relative to the second component (each of the seat rails 130) along an adjustment path W. As will be explained in more detail below, the transmission 121 is designed as a non-self-locking transmission.

The vehicle seat 1 further comprises a control system 14 operatively coupled to the motor 120, which is configured to put the motor 120 into a braking mode in order to lock the first component 10 relative to the second component 130. In braking mode, the motor exerts a braking force which counteracts a displacement of the seat portion 10 relative to the seat rails 130.

This prevents any unwanted displacement of the adjustment device 12 and thus of the seat portion 10 relative to the seat rails 130, even in the absence of self-locking of the transmission 121.

In the present example, the first component is the seat portion 10 and the second component is the seat rails 130. It should be noted, however, that another first component (e.g., each of the seat rails 130 or a component/assembly firmly connected thereto) of the vehicle seat 1 can also be adjustable relative to another second component (e.g., the corresponding floor rail 131 or a component/assembly firmly connected thereto) by an adjustment device, the motor of which can be put into a braking mode by the (or a) control system 14, as described. Such a first and a second component can in each case be a single part or an assembly of several individual parts.

The vehicle seat 1 further comprises at least one lock 15. In the present case, the vehicle seat 1 comprises a lock 15 on each side, i.e., two such locks 15. One of the locks 15 comprises a hook that can engage behind a bolt. The hook is movably mounted (here pivot-mounted) on the seat portion 10, and the bolt is fixed to one of the seat rails 130. If the seat portion 10 with the backrest 11 is moved slightly further back from the position shown in FIG. 1 by means of the easy entry adjustment device 12, then the hook is able to engage behind the bolt (at each of the two locks 15) to lock the corresponding lock 15.

If the locks 15 are locked, an adjustment using the easy entry adjustment device 12 will be blocked. The vehicle seat 1 is then locked in the occupiable position of use.

To move the vehicle seat 1 into the easy entry position, the locks 15 are unlocked (by pivoting the hooks out of engagement with the respective bolt). The motor 120 of the easy entry adjustment device 12 is then activated to perform the movement into the easy entry position. In the easy entry position, the control system 14 puts the motor 120 into braking mode.

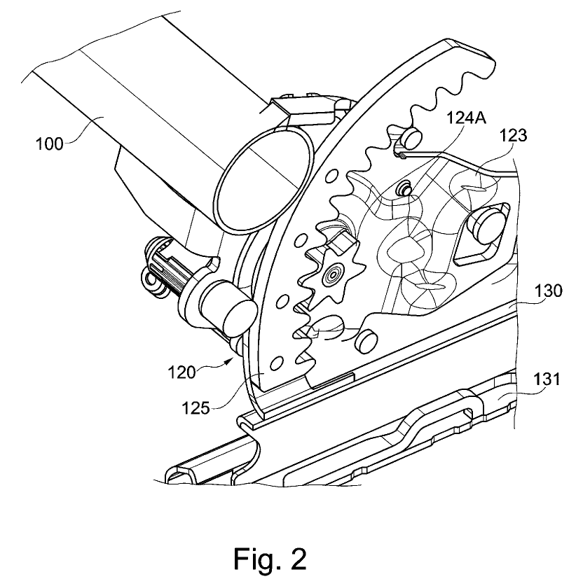

FIG. 2 shows a possible embodiment of parts of the aforementioned transmission 120. Shown is one of the floor rails, on which one of the seat rails 130 is mounted as a second component in a longitudinally displaceable manner. One of the rear pivot elements 123 is also shown and is pivot-mounted on the seat rail 130. For the sake of simplicity, only one transverse tube 100 of the seat portion 10 is shown as a first component in FIG. 2. In the present case, an arcuate toothed segment 125 is fixedly mounted on the second component, here on the seat rail 130. This toothed segment 125 is in toothed engagement with a gear 124A. The gear 124A can roll up and down on the toothed segment 125 to move the seat portion 10 from the position of use to the easy entry position, and vice versa. It should be noted that the vehicle seat 1 can have a motor 120 and a transmission 121 on each of the two sides, or only on one of the two sides. It should further be noted that the drive via a toothed segment is only one of several examples.

FIG. 3 shows the gear 124A from FIG. 2 with further parts of the transmission 120. The gear 124A is attached coaxially to a further gear 124B with a comparatively larger diameter. It is in toothed engagement with a comparatively smaller (third) gear 124C. The third gear 124C is fixedly connected to a motor shaft of the motor 120. Rapid rotation of the motor shaft of the motor 120 thus causes a comparatively slower rotation of the gear 124A. However, the gear ratio is not designed such that the transmission would form a self-locking mechanism. Instead, the transmission is not self-locking.

If the vehicle seat 1 is, for example, folded forward into the easy entry position and a passenger pulls himself up on the backrest 11 of the vehicle seat, the seat portion 10 could be unintentionally displaced relative to the seat rails 130, unless the control system 14 puts the motor 120 into braking mode.

FIG. 4 illustrates an exemplary electrical connection of the motor 120.

As shown, the control system 14 comprises a full bridge 146, and the motor is electrically connected via the full bridge 146 to a supply voltage V and a ground potential GND. The full bridge 146 comprises four switching elements 143A-143D, here each in the form of a power MOSFET (alternatively, for example, each in the form of an IGBT).

A first electrical terminal A1 of the motor 120 is connected to the supply voltage V via a switching element 143A. A second electrical terminal A2 of the motor 120 is connected to the supply voltage V via a further switching element 143B.

The first electrical terminal A1 is further connected to the ground potential GND via a further switching element 143C and the second electrical terminal A2 is further connected to the ground potential GND via a further switching element 143D. A freewheeling diode 147 is connected in parallel with each of the switching elements 143A-143D.

In braking mode, the electrical terminals A1 and A2 are short-circuited to one another. Specifically, the control system 14 is configured to open the switching elements 143A, 143B between the motor 120 and the supply voltage V and to close the switching elements 143C, 143D between the motor 120 and the ground potential GND in order to put the motor 120 into braking mode.

The control system 14 further comprises a lock switch 144, wherein a switching position of the lock switch 144 indicates whether the at least one lock 15 is locked or not. The lock switch 144 is mounted on the lock 15 in such a way that the lock switch 144 is actuated when the lock 15 is locked.

The lock switch 144 is, for example, designed in the form of a microswitch.

The control system 14 checks, on the basis of the switching position of the lock switch 144, whether the at least one lock 15 is locked or not. If the switching position indicates that the lock 15 is locked, then the control system 14 will not put the motor 120 into braking mode. If, however, the switching position indicates to the control system 14 that the lock 15 is unlocked, then the motor 120 will be put into braking mode.

The control system 14 has a sleep mode in which it is deactivated and consumes no power. The control system 14 comprises a gate driver 145, which is provided to put the motor 120 into braking mode when the control system 14 is put into sleep mode. For this purpose, the gate driver 145 recognizes that the control system 14 is being put into sleep mode and opens the switching elements 143A, 143B to the supply voltage V and closes the switching elements 143C, 143D to the ground potential GND.

The control system 14 comprises an interface 141 and is configured to receive a command to enter sleep mode via the interface 141, e.g., from a central vehicle control unit, and to enter sleep mode in response thereto.

If the control system 14 is active, it will switch the full bridge 146 to ground if the lock 15 is open and the motor 120 is not currently performing an adjustment. If the control system 14 is inactive, e.g., in sleep mode, the gate driver 145 will ensure activation of the braking function.

Even if the motor 120 brakes an adjustment, a force acting on the vehicle seat 1 for a long time (e.g., overnight) can cause an adjustment of the easy entry adjustment device 12 in the absence of self-locking of the transmission 120. Since the control system 14 adjusts the easy entry adjustment device 12 on the basis of a monitored absolute position of the first component (seat portion 10) along the adjustment path W, errors might occur due to the control system 14 not being able to monitor this position when it is in sleep mode. Thus, after a longer break, the absolute position calculated in the control system 14 on the basis of a number of motor revolutions from an end stop may deviate from the actual absolute position. For this reason, the control system 14 is configured to determine the correct position.

For this purpose, the vehicle seat 1 comprises one or more position encoders 16. If these are overrun, the control system 14 detects a corresponding position signal of the position encoder 16. Since the position encoder 16 outputs its position signal at a known position, the control system 14 corrects the monitored value of the absolute position at the position of the position encoder 16 with the predetermined value. In this way, the control system 14 controls the motor 120 as a function of the position signal.

The position encoder 16 comprises, for example, a position switch 160, in particular in the form of a microswitch, which is configured to change a switching state when the first component 10 reaches the predefined position during a movement along the adjustment path W.

For position correction, for example the rising flank or the falling flank of the by the switching operation of the position switch 160 can be used.

The position switch 160 can be designed in such a way as to change its switching state only when overrun (e.g., from a HIGH level to a LOW level, or vice versa) or can be designed in such a way as to have one switching state (e.g., the HIGH level or the LOW level) when adjusted from the usable position to the position switch 160 and to have another switching state from there to the easy entry position.

If the control system 14 (e.g., control unit, in particular seat control unit) wakes up with an unchanged switching state of the position switch 160, i.e., for example, the same level of the position switch 160 (e.g., of the position microswitch) that it registered before or during the previous transition from active mode to sleep mode, the control system 14 will be able to assume a valid position. The control system 14 is, for example, configured to allow automatic and/or motorized adjustment in this case, for example when input via a corresponding command.

However, if the control system 14 wakes up with a different switching state of the position switch 160 (switches from sleep mode to active mode), i.e., for example, with a correspondingly different level of the position switch 160, it will assume a greater change in position. For this reason, the control system 14 is configured here, for example, to not (no longer) allow automatic adjustments and/or adjustments driven by the motor 120. For example, only user-initiated adjustments are permitted (also referred to as dead-man's adjustment), e.g., a motorized adjustment for the duration of a keystroke or activation of another element of a user interface. According to a further example, it may be provided for the control system 14 to release, i.e., to deactivate, the brake mode in this case so that manual adjustment is possible. It may be provided for the control system 14 to deactivate the braking mode only for as long as a button is being pressed (or another element of a user interface, HMI, is activated). The control system 14 can be configured to reactivate the braking mode as soon as the button is released (actuation is terminated), provided that the lock switch 144 indicates that the vehicle seat 1 is not locked in the position of use.

As an alternative or in addition to the position switch 160, the position encoder 16 can comprise a local mechanical deviation 161 at the adjustment device 12, which is detectable by the control system 14 on the basis of a characteristic deviation in the operation of the motor 120 when the first component 10 reaches the predefined position during a movement along the adjustment path W. FIG. 1 illustrates the mechanical deviation as a projection. In order to pass over the projection, a higher torque must be applied, which the control system 14 detects. Based on this, the absolute position can be normalized. Furthermore, a reduced rotational speed and/or an increased current value are further indicators by which the control system 14 can detect the position marker. The local deviation can also take the form of a depression or the like. FIG. 1 illustrates the mechanical deviation 161 at the longitudinal adjustment device 13; however, a corresponding local mechanical deflection can also be provided at the easy entry adjustment device 12 (e.g., at a rotary bearing).

The control system 14 can have an excess force limitation as an alternative or additional feature to the braking function. For this purpose, the control system 14 can be configured to measure the force acting on the adjustment device 12 during activation of the adjustment device 12, e.g., in the form of the applied torque, and to deactivate the motor 120 of the adjustment device (e.g., of the easy entry adjustment device 12) if the force exceeds a threshold, wherein the threshold is position-dependent and has a different value when the first component (here, seat portion 10) is in a position between the predefined position and one of two ends of the adjustment path W than when the first component is in a position between the predefined position and the other of the two ends of the adjustment path W. In this way, the excess force limitation can be restricted to a range where anti-pinch protection is necessary, and a higher threshold can be applied in other adjustment ranges (or excess force limitation can be omitted entirely).

The control system 14 comprises a processor 142 and a storage medium 140, on which instructions are stored which, when executed by the processor 142, cause the control unit 14 to perform the functions described above.

### LIST OF REFERENCE SIGNS

1 Vehicle seat
10 Seat portion (first component)
100 Cross-tube
11 Backrest
12 Easy entry adjustment device (adjustment device)
120 Motor
121 Transmission
122 Pivot element
123 Pivot element 124A-124C
Gear
125 Toothed segment
13 Longitudinal adjustment device
130 Seat rail (second component)
131 Floor rail
14 Control system
140 Storage medium
141 Interface
142 Processor
143A-143D Switching element
144 Lock switch
145 Gate driver
146 Full bridge
147 Freewheeling diode
15 Lock
16 Position encoder
160 Position switch
161 Mechanical deviation
17 Fitting
2 Vehicle floor
GND Ground potential
A1, A2 Terminal
V Supply voltage
W Adjustment path
X Longitudinal direction
Y Transverse direction
Z Height direction

What is claimed is:

1. A vehicle seat comprising:
a first component,
a second component,
an adjustment device having a motor and a transmission for adjusting the first component relative to the second component along an adjustment path, wherein the transmission is designed as a non-self-locking transmission, and,
a control system which is configured to put the motor into a braking mode to lock the first component relative to the second component.

2. The vehicle seat according to claim 1, wherein the motor has at least or exactly two electrical terminals which are short-circuited in braking mode.

3. The vehicle seat according to claim 1, wherein the control system comprises a full bridge, wherein the motor is electrically connected via the full bridge to a supply voltage and a ground potential.

4. The vehicle seat according to claim 3, wherein the full bridge comprises four switching elements, in particular each in the form of an Insulated-Gate Bipolar Transistor (IGBT) or each in the form of a metal oxide semiconductor field-effect transistor (MOSFET).

5. The vehicle seat according to claim 4, wherein two of the switching elements are connected between the motor and the supply voltage and two of the switching elements are connected between the motor and the ground potential, wherein the control system is configured to open the switching elements between the motor and the supply voltage and to close the switching elements between the motor and the ground potential in order to put the motor into braking mode.

6. The vehicle seat according to claim 1, wherein the first component is a seat portion on which a passenger can sit, wherein the seat portion is supported on the second component.

7. The vehicle seat according to claim 1, wherein the adjustment device comprises pivot elements which are pivotably mounted relative to the first component and relative to the second component.

8. The vehicle seat according to claim 1, wherein at least one lock by means of which the first component can be locked in a predetermined position relative to the second component.

9. The vehicle seat according to claim 8, wherein the control system comprises a lock switch, in particular in the form of a microswitch, wherein a switching position of the lock switch indicates whether the at least one lock is locked or not.

10. The vehicle seat according to claim 9, wherein the control system is configured to put the motor into braking mode if the switching position of the lock switch indicates that the at least one lock is not locked.

11. The vehicle seat according to claim 1, wherein the control system has a sleep mode in which the control system is at least partially deactivated and wherein the control system comprises a gate driver which is configured to put the motor into braking mode when the control system is in sleep mode and/or when the control system is put into sleep mode.

12. The vehicle seat according to claim 11, wherein the control system comprises an interface and is configured to receive a command to enter sleep mode via the interface and to enter sleep mode in response thereto.

13. The vehicle seat according to claim 1, wherein a position encoder which is configured to output a position signal indicating whether the first component is positioned in a predefined position along the adjustment path or not, wherein the control system is configured to control the motor of the adjustment device as a function of the position signal.

14. The vehicle seat according to claim 13, wherein the control system is configured to determine a current position of the first component relative to the second component by counting a number of motor revolutions of the motor starting from an end position, wherein the control system is further configured to set the current position to a predetermined value when the position signal indicates that the first component is positioned in the predefined position along the adjustment path.

15. The vehicle seat, in particular according to claim 1, comprising:
a first component,
a second component,
an adjustment device having a motor for adjusting the first component relative to the second component along an adjustment path,
a position encoder which is configured to output a position signal indicating whether the first component is positioned in a predefined position along the adjustment path or not, and,
a control system which is configured to control the motor of the adjustment device as a function of the position signal.

16. The vehicle seat according to claim 13, wherein the position encoder comprises a position switch, in particular in the form of a microswitch, which is configured to change a switching state when the first component reaches the predefined position during a movement along the adjustment path.

17. The vehicle seat according to claim 13, wherein the position encoder comprises a local mechanical deviation at the adjustment device, which is detectable by the control system on the basis of a characteristic deviation in the operation of the motor when the first component reaches the predefined position during a movement along the adjustment path.

18. The vehicle seat according to claim 17, wherein the characteristic deviation in the operation of the motor is a local increase or decrease in rotational speed and/or current value.

19. The vehicle seat according to claim 1, wherein the control system is configured to detect an indicative value of a force acting on the adjustment device during activation of the adjustment device and to deactivate the adjustment device if the detected value exceeds a threshold.

20. The vehicle seat according to claim 19, wherein a position encoder which is configured to output a position signal indicating whether the first component is positioned in a predefined position along the adjustment path or not, wherein the control system is configured to control the motor of the adjustment device as a function of the position signal, wherein the threshold has a different value when the first component is positioned between the predefined position and one of two ends of the adjustment path than when the first component is positioned between the predefined position and the other of the two ends of the adjustment path.
